(19) United States
(12) Patent Application Publication
(10) Pub. No.: US 2007/0131852 A1
(43) Pub. Date: Jun. 14, 2007

(54) Optical encoder, system and method for using the same

(76) Inventor: Bryce Welch, Chicago, IL (US)

Correspondence Address: PATENTS+TMS;A Professional Corporation, 2849 W. Armitage Ave., Chicago, IL, 60647, US

(21) Appl. No.: 11/300,179

(22) Filed: Dec. 14, 2005

(51) Int. Cl. G01D 5/34

(52) U.S. Cl. 250/231.13

(57) ABSTRACT

An optical encoder, a system and a method for using the same which has a shaft extending from within an interior of a housing. A light emitting element, a light detector and a plate are located within the interior of the housing. The plate is connected to the shaft. Movement of the shaft may move the plate to block, to deflect and/or to absorb light from the light emitting element. The light detector senses and/or detects movement of the shaft by an amount, a direction and/or an intensity of light transmitted by the light emitting element. The shaft rotates, twists and/or turns to move a shutter which blocks, reflects, absorbs and/or deflects light from the light emitting element. The shaft contacts a spring and/or a ball to produce a sounds which indicates the shaft is rotating, twisting and/or turning. The light detector outputs a signal via a cable based on the amount, the direction and/or the intensity of light. The signal corresponds to the position and/or location of the shaft.

### BACKGROUND OF THE INVENTION

The present invention generally relates to an optical encoder, a system and a method for using the same. More specifically, the present invention relates to an optical encoder and a system which optically detects movement of a shaft with a light emitting element and/or a light detector.

The optical encoder, the system and the method for using the same may have a housing. The shaft may extend from an interior of the housing to a first distance exterior to the housing. The light emitting element, the light detector and/or a plate may be within the interior of the housing. The light detector may sense and/or may detect light from the light emitting element which may be a light emitting diode. The plate may be connected to, attached to and/or secured to the shaft. Movement of the shaft may move the plate to block, to deflect and/or to absorb light from the light emitting element. The light detector which may be, for example, a photodetector, may sense and/or may detect movement and/or a position of the shaft by an amount, a direction and/or an intensity of light transmitted by the light emitting element. The shaft may rotate, may twist and/or may turn to move a shutter which may block, may interrupt, may absorb and/or may deflect light from the light emitting element. The shaft may contact a ball and/or a spring to produce a sound to indicate the shaft is rotating, twisting and/or turning. A cable and/or terminal pins may output a signal based on the direction, the amount and/or the intensity of light. The signal may correspond to the position of the shaft. The shaft may be depressed to contact a push button connected to a detector board which may output the signal via the cable and/or the terminal pins.

It is generally known to use a switch having a knob to turn and/or to push the switch from a first position to a second position to output an electrical signal. The shaft contacts a circuit by, for example, an arm attached to the shaft. As the shaft turns, the shaft engages one of an array of points within a circuit which are arranged around the shaft. The circuit is closed in a loop by the contact with the shaft. As a result, the electrical signal is output to indicate the location of the shaft. The repeated contact of mechanical parts, such as, the shaft with the circuit causes the device to frequently fail. Points within the circuit may chip and/or may separate from the circuit. After repeated use, the shaft may rotate without the arm contacting the circuit and/or without the contact of the circuit closing the loop of the circuit.

It is also generally known to use a magnetic switch to determine a position of a rotating shaft. The magnetic switch and a Hall effect sensor determine the position of the rotating shaft. The Hall effect sensor responds to changes in magnetic field density created by the rotating shaft changing positions. The magnetic switch has a magnet on the shaft and a Hall effect sensor at a selected position. As the shaft rotates, the magnet on the shaft moves with respect to the Hall effect sensor creating a magnetic field which is detected by the Hall effect sensor. As a result, the Hall effect sensor may detect the location of the shaft. Typically, the magnetic switch forces the shaft to an initial position after the shaft is rotated. The movement of the shaft is limited by the locations of the Hall effect sensor. As a result, turning the magnetic switch only identifies and/or detects two positions of the shaft, such as, for example, “on” and “off”. Because location of the shaft is magnetically determined, no sound, such as a clicking noise, occurs when the shaft is turned and/or moved to a second position. Often, using magnetically charged components to detect the location of the shaft is inaccurate.

A need, therefore, exists for an optical encoder, a system and a method for using the same having a shaft, a light emitting element and/or a light detector which optically detects a location and/or a position of the shaft. Additionally, a need exists for an optical encoder, a system and a method for using the same having a shaft with a detent profile to maintain the shaft in position and provide feedback to a user. Further, a need exists for an optical encoder, a system and a method for using the same having a shaft wherein rotating the shaft moves a plate to block, to interrupt and/or to absorb light transmitted from a light emitting element. Still further, a need exists for an optical encoder, a system and a method for using the same having a shaft wherein pressing the shaft sends an electrical output to indicate the position of the shaft. Moreover, a need exists for an optical encoder, a system and a method for using the same having a push button to transmit an electrical signal from the optical encoder when the shaft is depressed. Furthermore, a need exists for an optical encoder, a system and a method for using the same having a shaft wherein depressing and/or pushing the shaft depresses a push button to provide tactile feedback to a user. In addition, a need exists for an optical encoder, a system and a method for using the same having a shaft wherein rotating the shaft produces a sound to indicate that the shaft is rotating. Further, a need exists for an optical encoder, a system and a method for using the same having a shaft wherein rotating the shaft moves a shutter to block, to absorb and/or to interrupt light. Still further, a need exists for an optical encoder, a system and a method for using the same having a shaft wherein rotating, sliding and/or laterally moving the shaft changes an amount, an intensity and/or a direction of light. Moreover, a need exists for an optical encoder, a system and a method for using the same having a shaft wherein movement of the shaft outputs an electrical signal to indicate a location and/or a position of the shaft. Furthermore, a need exists for an optical encoder, a system and a method for using the same which provides a nearly infinite life of components of the optical encoder and/or the system.

### SUMMARY OF THE INVENTION

The present invention relates to an optical encoder, a system and a method for using the same. More specifically, the optical encoder, the system and the method for using the same may optically detect movement of a shaft to output a signal which may correspond to a position and/or a location of the shaft. The shaft may extend from an interior of a housing to a distance exterior to the housing. The housing may have a top side and a bottom side. The shaft may attach to, may secure to and/or may connect to the bottom side of the housing. The interior of the housing may have a shutter, a plate, a light emitting element and/or a light detector. The light emitting element may transmit and/or emit light from a first location within the interior of the housing to a second location within the interior of the housing. In addition, the light emitting element may transmit light to the exterior of the housing. The shaft may abut and/or may connect to the shutter. Rotating the shaft may engage and/or may move the shutter to change an amount and/or a direction of light provided to the light detector. The shaft may contact, may abut and/or may connect to the plate. Moving and/or sliding the shaft may move the plate to change the amount and/or the direction of light provided to the light detector. The light detector may output and/or transmit a signal which may correspond to the location and/or the position of the shaft. A ball and spring may maintain the shaft in a central position with respect to the housing. The ball and/or the spring may contact the shaft. Turning and/or rotating the shaft may contact the ball and/or the spring to produce a sound to indicate that the shaft is rotating and/or turning. The shaft may be depressed and/or pushed inward with respect to the housing to contact a push button. The push button may provide tactile feedback to the user.

To this end, in an embodiment of the present invention, an optical encoder is provided. The optical encoder has a housing having an interior wherein the interior is defined between a top side and a bottom side. Further, the optical encoder has a first shaft connected to the interior of the housing wherein the first shaft extends outward with respect to the interior of the housing through the top side of the housing to a point exterior to the housing. Still further, the optical encoder has a light emitting element connected to the interior of the housing wherein the light emitting element transmits an amount of light within the interior of the housing. Moreover, the optical encoder has a light detector connected to the interior of the housing wherein the light detector detects the amount of light transmitted from the light emitting element. Furthermore, the optical encoder has a plate connected to the interior of the housing and the first shaft wherein the plate is located between the light emitting element and the light detector wherein movement of the first shaft from a first position to a second position moves the slide plate to change the amount of light detected by the light detector.

In an embodiment, the optical encoder has a second shaft connected to the interior of the housing and the plate wherein the second shaft extends outward with respect to the interior of the housing.

In an embodiment, the optical encoder has a shutter connected to the first shaft wherein movement of the shutter changes the amount of light detected by the light detector.

In an embodiment, the optical encoder has a cable connected to the light detector wherein the cable transmits a signal based on the amount of light detected by the light detector.

In an embodiment, the optical encoder has a push button within the housing wherein depressing the shaft contacts the push button.

In an embodiment, the optical encoder has a plate connected to the first shaft wherein the plate separates the light emitting element from the light detector.

In another embodiment of the present invention, a system for encoding an amount of light is provided. The system has a housing having an interior wherein the interior is defined between a top side and a bottom side. Further, the system has a first shaft connected to the interior of the housing wherein the first shaft extends outward with respect to the interior of the housing through the top side of the housing to a point exterior to the housing. Still further, the system has a light emitting element connected to the interior of the housing wherein the light emitting element transmits an amount of light within the interior of the housing. Moreover, the system has a light detector connected to the interior of the housing wherein the light detector detects the amount of light transmitted from the light emitting element. Furthermore, the system has a shutter connected to the interior of the housing and the first shaft wherein the shutter is located between the light emitting element and the light detector and further wherein the first shaft rotates from a first position to a second position to move the shutter wherein movement of the shutter changes the amount of light detected by the light detector.

In an embodiment, the system has a second shaft connected to the interior of the housing wherein movement of the second shaft changes the amount of light detected by the light detector.

In an embodiment, the system has a plate connected to the first shaft wherein movement of the plate changes the amount of light detected by the light detector.

In an embodiment, the system has a cable connected to the light detector wherein the cable transmits a signal corresponding to the second position of the first shaft.

In an embodiment, the system has a push button within the housing wherein depressing the shaft contacts the push button.

In an embodiment, the system has a plate connected to the first shaft wherein the plate separates the light emitting element from the light detector.

In an embodiment, the system has a ball connected to the top side of the housing wherein movement of the first shaft abuts the ball to produce a sound.

In another embodiment of the present invention, a method for using an optical encoder is provided.

In an embodiment, the method has the step of providing a housing having an interior defined between a top side and a bottom side wherein the interior of the housing has a shaft extending outward with respect to the interior through the top side of the housing. Further, the method has the step of emitting an amount of light within the interior of the housing from the top side of the housing. Still further, the method has the step of detecting the amount of light within the interior of the housing at the bottom side. Moreover, the method has the step of changing the amount of light detected at the bottom side via the shaft. Moreover, the method has the step of transmitting an electrical signal based on the amount of the light detected within the interior of the housing at the bottom side and further wherein the electrical signal corresponds to a location of the shaft within the interior of the housing.

In an embodiment, the method has the step of inserting a plate between the top side and the bottom side of the interior of the housing wherein movement of the plate changes the amount of light detected at the bottom side of the interior of the housing.

In an embodiment, the method has the step of connecting a light emitting element to the top side of the interior of the housing wherein the light emitting element emits the amount of light into the interior of the housing.

In an embodiment, the method has the step of connecting a light detector to the bottom side of the interior of the housing wherein the light detector detects the amount of light at the bottom side of the interior of the housing.

In an embodiment, the method has the step of contacting a push button with the shaft wherein depressing the shaft contacts the push button to transmit the electrical signal.

In an embodiment, the method has the step of connecting a cable to the housing wherein the electrical signal is transmitted via the cable.

In an embodiment, the method has the step of connecting a shutter to the shaft wherein movement of the shutter changes the amount of light detected at the bottom side of the interior of the housing.

It is, therefore, an advantage of the present invention to provide an optical encoder, a system and a method for optically detecting movement of a shaft which may optically detect a position and/or a location of the shaft.

Another advantage of the present invention is to provide an optical encoder, a system and a method for optically detecting movement of a shaft whereby rotating the shaft moves a shutter to change a location, an intensity and/or an amount of light transmitted to a light detector.

And, another advantage of the present invention is to provide an optical encoder, a system and a method for optically detecting movement of a shaft by outputting an electrical signal from the light detector.

Yet another advantage of the present invention is to provide an optical encoder, a system and a method for optically detecting movement of a shaft by outputting an electrical signal corresponding to a location and/or a position of the shaft.

A further advantage of the present invention is to provide an optical encoder, a system and a method for optically detecting movement of a shaft whereby the shaft contacts and/or engages a plate to change an amount and/or an intensity of the light transmitted to the light detector.

Moreover, an advantage of the present invention is to provide an optical encoder, a system and a method for optically detecting movement of a shaft wherein the shaft is maintained in a central position with respect to a housing by a detent profile.

And, another advantage of the present invention is to provide an optical encoder, a system and a method for optically detecting movement of a shaft wherein rotation of the shaft produces a sound indicating that the shaft is rotating.

Yet another advantage of the present invention is to provide an optical encoder, a system and a method for optically detecting movement of a shaft optically to preserve a longer life of the optical encoder and/or the system.

Another advantage of the present invention is to provide an optical encoder, a system and a method for optically detecting movement of a shaft wherein the shaft may be depressed and/or pushed to contact a push button which may provide tactile feedback.

A still further advantage of the present invention is to provide an optical encoder, a system and a method for accurately detecting movement of a shaft by interaction between a light detector and a light emitting element.

Additional features and advantages of the present invention are described in, and will be apparent from, the detailed description of the presently preferred embodiments and from the drawings.

### BRIEF DESCRIPTION OF THE DRAWINGS

FIG. 1 illustrates a side plan view of a shaft within a housing having a cable in an embodiment of the present invention.

FIG. 2 illustrates a perspective view of the housing with a cable and a shaft in an embodiment of the present invention.

FIG. 3 illustrates an exploded perspective view of the shaft, a housing and a plate in an embodiment of the present invention.

FIG. 4 illustrates a black box diagram of a system using an optical encoder to optically detect movement of a shaft.

### DETAILED DESCRIPTION OF THE PREFERRED EMBODIMENTS

The present invention relates to an optical encoder, a system and a method for optically detecting movement of a first shaft and/or a second shaft. The first shaft and/or the second shaft may be within a housing having an interior. The first shaft and/or the second shaft may extend to a distance exterior to the housing. The first shaft and/or the second shaft may connect to and/or attach to the housing. The first shaft may move laterally, transversely, inward with respect to the housing and/or outward with respect to the housing. The second shaft may rotate, turn, move inward with respect to the housing and/or outward with respect to the housing. Moving the first shaft and/or the second shaft inward with respect to the housing may contact a push button and may provide tactile feedback to a user. Rotating the first shaft and/or the second shaft may contact a detent profile which may produce a sound to indicate the first shaft and/or the second shaft is rotating.

A light emitting element may be located within the housing and may transmit light from a first location to a second location within the housing. A plate and/or a shutter may be positioned between the light emitting element and a light detector. The first shaft and/or the second shaft may abut and/or may contact the plate and/or the shutter. Movement of the first shaft and/or the second shaft may move the plate and/or the shutter to deflect, to interrupt, to absorb and/or to block light transmitted from the light emitting element. The light detector may output an electrical signal based on an amount and/or an intensity of light from the light emitting element. The electrical signal may correspond to a location and/or a position of the first shaft and/or the second shaft.

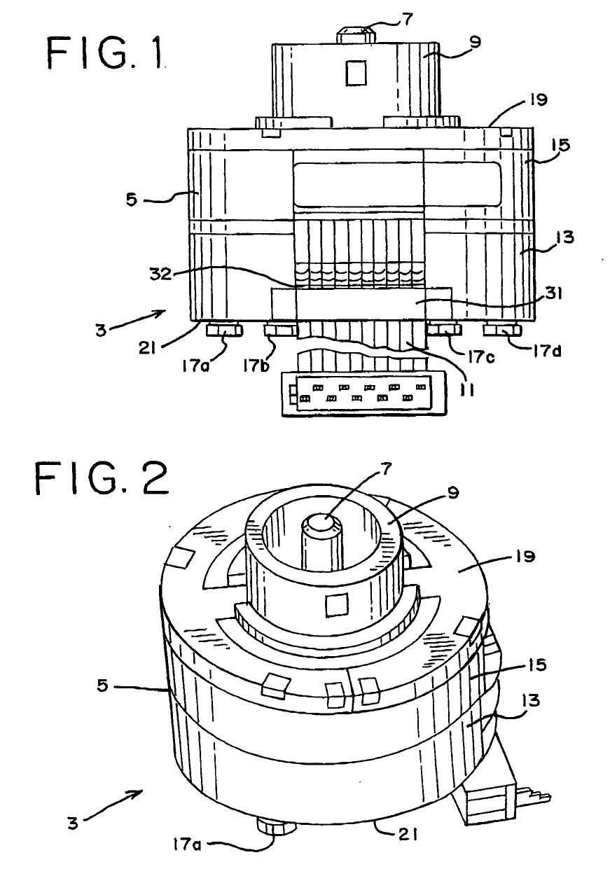

Referring now to the drawings wherein like numerals refer to like parts, FIG. 1 and FIG. 2 illustrate a system 3 and a housing 5 which may have a first shaft 7, a second shaft 9 and/or a cable 11. The housing 5 may have a top portion 15 and a bottom portion 13. Pins 17a-17d may connect, may secure and/or may attach the top portion 15 to the bottom portion 13 of the housing 5 to define an interior of the housing 5. The pins 17a-17d may extend through the interior of the housing 5. The top portion 15 of the housing 5 may have a top side 19. The bottom portion 13 of the housing 5 may have a bottom surface 21.

The first shaft 7 may extend through the second shaft 9. The first shaft 7 may move horizontally, vertically, diagonally and/or transversely with respect to the top side 19 of the housing 5. The first shaft 7 and/or the second shaft 9 may rotate and/or turn with respect to the housing 5. The first shaft 7 and/or the second shaft 9 may depress and/or may move toward the bottom surface 21 of the housing 5. Movement of the first shaft 7 and/or the second shaft 9 may be converted to a signal, for example, an electrical signal, within the housing. The cable 11 may output the signal from the housing 5. Terminal pins, electrical contacts and/or the like may output the signal from the housing 5. The signal may correspond to a location and/or a position of the first shaft 7 and/or the second shaft 9. The present invention should not be deemed limited to a specific device and/or method of outputting the signal from the housing. The signal may be output by any device and/or method as known to one having ordinary skill in the art.

The cable 11 may attach to and/or may connect to the bottom portion 13 of the housing 5. The clamp 31 may position, may hold and/or may guide the cable 11 as the cable 11 extends from the interior of the housing 5. The clamp 31 may be formed with the bottom portion 13 of the housing 5. The clamp 31 may attach to and/or secure to the bottom portion 13. The cable 11 may extend through an opening 32 which may be between the clamp 31 and the bottom portion 13.

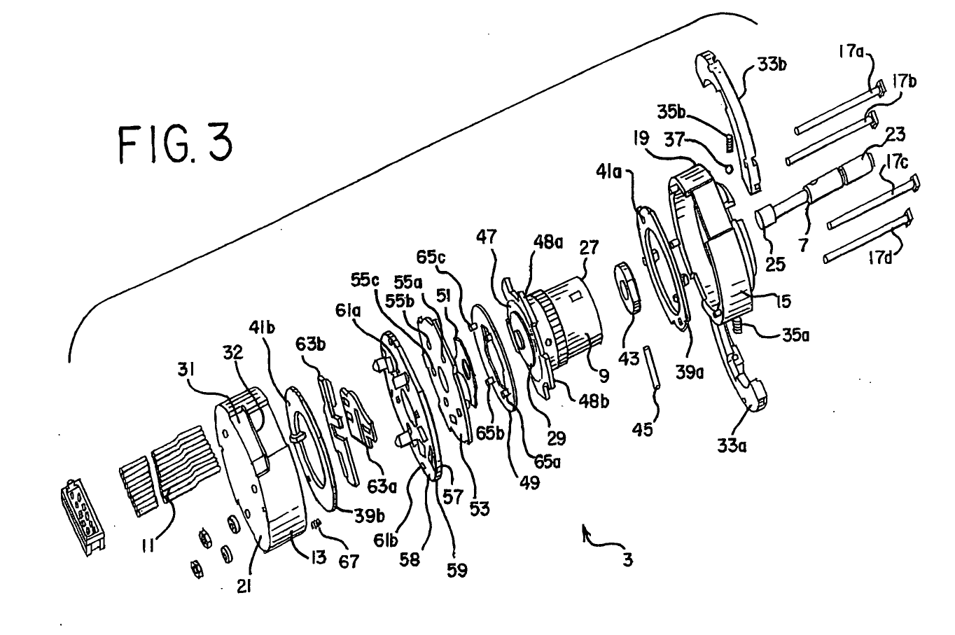

FIG. 3 illustrates an exploded view of the optical encoder 4 and the system 3 in an embodiment of the present invention. The housing 5 may define an interior between the top portion 15 and the bottom portion 13 of the housing 5. As illustrated in FIG. 3, the housing 5 may be circular-shaped, elliptically-shaped and/or the like.

The first shaft 7 may have a length defined between a first end 23 and a second end 25. The first end 23 may extend a first distance outward from the top side 19 of the housing 5. The second end 25 may connect to and/or secure to the bottom surface 21 of the housing 5. The second shaft 9 may have a length defined between a distal end 27 and a proximate end 29. The second shaft 9 may have an interior between the distal end 27 and the proximate end 29. The distal end 27 is opposite the proximate end 29. The first shaft 7 may extend through the interior of the second shaft 9.

The second shaft 9 may extend a second distance outward from the top side 19 of the housing 5. The first distance may be greater than the second distance. The first shaft 7 and the second shaft 9 may extend within the housing 5. The pins 17a-17d may extend through the top side 19 and/or the bottom surface 21 of the housing 5 to secure the top portion 15 to the bottom portion 13. The top side 19 of the housing 5 may have guides 33a, 33b. The guides 33a,33b may contact and/or may abut the top side 19 of the housing 5. The guides 33a,33b may be translucent and/or may be transparent to allow light from the interior of the housing 5 to project to the exterior of the housing 5. The pins 17a-17d may extend through the guides 33a,33b. The guides 33a,33b may position the pins 17a-17d as the pins 17a-17d extend through the interior of the housing 5. The guides 33a,33b may have holes, gaps and/or pockets to position, to secure and/or to hold springs 35a,35b. A ball 37 may be positioned between the springs 35a,35b and the top side 19 of the housing 5. The springs 35a,35b may force the ball 37 to abut and/or to contact the top side 19 of the housing 5. Interaction between the springs 35a,35b and the ball 37 may produce sounds and/or vibrations as the first shaft 7 and/or the second shaft 9 rotates, turns, slides, moves, changes position and/or the like.

Emitter boards 39a,39b may be positioned within the interior of the housing 5. The pins 17a-17d may extend through the emitter plates 39a,39b to hold and/or to secure the emitter plates 39a,39b in position within the housing 5. The emitter plate 39a may have light emitting elements 41a,41b which may be, for example, light emitting diodes which may transmit visible light, infrared light and/or the like. The light emitting elements 41a,41b may transmit visible light through the guides 33a,33b to the exterior of the housing 5. The light emitting elements 41a,41b may transmit infrared light within the housing 5. The first shaft 7 and/or the second shaft 9 may extend through an opening in the emitter board 39a.

The first shaft 7 may extend through the top side 19 into the interior of the housing 5. As illustrated in FIG. 3, the first shaft 7 may be circularly-shaped, elliptically-shaped and/or the like. The first shaft 7 may extend within the second shaft 9. The first shaft 7 may attach to, may secure to and/or may connect to a rocker 43 which may be a joint, such as, for example, a universal joint. The rocker 43 may attach, may secure and/or may couple the first shaft 7 to the second shaft 9. The rocker 43 allows the first shaft 7 to move in any direction. For example, the first shaft 7 may twist and/or may rotate. As the first shaft 7 rotates, the rocker 43 may rotate the second shaft 9. Alternatively, the first shaft 7 may rotate with respect to the second shaft 9. The rocker 43 allows the first shaft 7 to move inward with respect to the interior of the housing 5. For example, the first shaft 7 may be pushed and/or depressed within the housing 5. The rocker 43 allows the first shaft 7 to move laterally, horizontally and/or transversely with respect to the second shaft 9. The first shaft 7 may attach to, may connect to and/or may secure to the bottom surface 21 of the housing 5.

A rocker pin 45 may connect and/or may secure the first shaft 7 to the rocker 43. The rocker pin 45 may be a rod, a bolt, a pin or the like. The rocker pin 45 may be any attaching mechanism and/or securing mechanism known to one having ordinary skill in the art.

The second shaft 9 may extend from within the housing 5 to the proximate end 27 which may be exterior to the housing 5. The second shaft 9 may extend through the emitter board 39a and may rotate with respect to the housing 5. The second shaft 9 may contact and/or may engage the ball 37 and/or the springs 35a,35b. As illustrated in FIG. 3, the second shaft 9 may be circularly-shaped, elliptically-shaped and/or the like. The first end 46 of the housing 5 may be connected to, attached to and/or secured to a knob, a dial, a handle or the like.

The second shaft 9 may be connected to, attached to and/or secured to a shutter 47 which may move as the second shaft 9 and/or the first shaft 7 rotates. The shutter 47 reflects, absorbs, blocks and/or deflects light transmitted from the light emitting element 41a. The shutter 47 may move and/or may rotate to change the amount of light, the intensity of light and/or the direction of light transmitted toward the bottom surface 21 of the housing 5. The shutter 47 may move, may open, may close and/or may rotate as the first shaft 7 and/or the second shaft 9 is depressed. The shutter 47 may have flaps 48a,48b extending outward to block, to deflect and/or to absorb light transmitted from the light emitting element 41a.

The second shaft 9 may abut and/or may contact a retainer board 49. The first shaft 7 may extend through the retainer board 49. The retainer board 49 may orient, may secure and/or may set the second shaft 9 on a push button 51. The retainer board 49 may be a plate, a washer and/or any connector known to one of ordinary skill in the art which may connect the second shaft 9 to the push button 51. The first shaft 7 may extend through the push button 51. The first shaft 7 may contact the push button 51. The push button 51 may be secured to, attached to and/or in contact with a detector board 53. Pushing and/or depressing the first shaft 7 and/or the second shaft 9 may depress the push button 51 to move a contact, such as for example, an electrical contact which may connect and/or may contact the detector board 53. The push button 51 may contact the detector board 53 to output a signal. The electrical signal may correspond to a location and/or to a position of the second shaft 9 and/or the first shaft 7. The push button 51 may provide feedback to a user when depressed and/or pushed. The feedback may be, for example, tactile feedback, touchable feedback, noise feedback and/or the like.

The first shaft 7 may extend through the detector board 53. The detector board 53 may have light detectors 55a-55c which may be, for example, light sensors, such as, for example, photodetectors. The light detectors 55a-55c may be connected to, attached to, and/or formed with a top surface 57 and/or a bottom surface 58 of the detector board 53. The detector board 53 may output the electrical signal via the cable. The signal may be based on an amount, an intensity and/or a direction of light transmitted from the light emitting elements 41a,41b via and/or the amount, the intensity and/or the direction of light detected by the light detectors 55a-55c. The detector board 53 may absorb, deflect, reflect and/or block light transmitted from the light emitting element 41a. The cable 11 may attach to, secure to and/or be in communication with the detector board 53 and/or the light detectors 55a-55c. The cable 11 may output a signal, such as, for example, an electrical signal. The signal may be based on an amount of light, an intensity of light and/or a direction of light received by and/or absorbed by the light detectors 55a-55c. The signal may correspond to a position and/or a location of the first shaft 7 and/or the second shaft 9.

A spacer 59 may be connected to, attached to and/or may contact the detector board 53. The spacer 59 may be a plate, a board, a washer and/or the like. The spacer 59 may have apertures 61a,61b which may extend through the spacer 59. Light may be transmitted through the apertures 61a,61b. The spacer 59 may have grooves, tracks, pegs and/or the like to guide slide plates 63a,63b as the slide plates 63a,63b move with respect to the spacer 59. Legs 65a-65c may be attached to and/or secured to the spacer 59.

The legs 65a-65c may allow the slide plates 63a,63b to slide, to move and/or to rotate with respect to the spacer 59. The slide plates 63a,63b may slide without contacting the emitter board 39b. The first shaft 7 may contact, may abut and/or may connect to the slide plates 63a,63b. Moving, twisting and/or depressing the first shaft 7 may move, may slide and/or may rotate the slide plates 63a, 63b. The slide plates 63a,63b may deflect, may absorb, may block and/or may reflect light transmitted from the emitter board 39b. The slide plates 63a,63b may slide, may rotate and/or may move to transmit light to the detector board 53. The slide plates 63a,63b may have openings, holes, slots and/or the like for light to transmit and/or pass through the slide plates 63a,63b. The light detector 41b may be attached to, secure to and/or connected to the emitter board 39b. The light detector 41b may transmit light from the emitter board 39b to the detector board 53. The first shaft 7 may extend through slide plates 63a,63b and/or the spacer 59.

The first shaft 7 may connect to, may secure to and/or may contact the bottom surface 59. A spring 67 may connect and/or may attach the first shaft 7 to the bottom surface 59. The first shaft 7 may move, may twist, may turn, may slide and/or may rotate with respect to the spring 67. The spring 67 may secure to and/or may attach to the bottom surface 59. Alternatively, the spring 67 may move with respect to the bottom surface 59.

In use, the first shaft 7 may move toward the second shaft 9. The first shaft 7 may move the slide plates 63a,63b to change an amount and/or a direction of light transmitted to the light detectors 55a-55c from the light emitting element 41b. The light detectors 55a-55c may detect the amount and/or the direction of the light to output a first electrical signal via the cable 11. The user may rotate the second shaft 9 to move the shutter 47 to change the amount and/or the direction of the light transmitted from the light emitting element 41a to the light detectors 55a-55c. The light detectors 55a-55c may detect the amount of light and/or the direction of light to output a second electrical signal via the cable 11. The user may depress and/or push the first shaft 7 and/or the second shaft 9 toward the bottom surface 59 of the housing 5. The first shaft 7 and/or the second shaft 9 may depress and/or push the push button 51 to contact the detector board 53 which may output a third electrical signal. The first electrical signal, for example, may be greater than the second electrical signal which may be greater than the third electrical signal. Each signal, respectively, may correspond to a location and/or a position of the first shaft 7 and/or the second shaft 9. The ball 37 and/or the spring 35a,35b may return the first shaft 7 to an initial position within the housing 5.

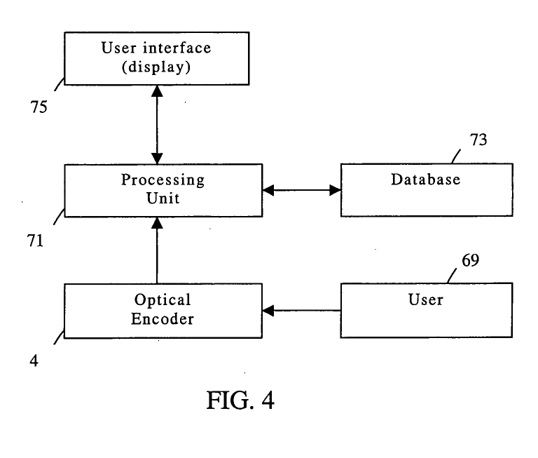

FIG. 4 illustrates a black box diagram of a system using an optical encoder to detect movement of a shaft in an embodiment of the present invention. The optical encoder 4 may be connected to and/or in communication with a processing unit 71 which may be connected to and/or in communication with a database 73. The processing unit 71 may be connected to and/or in communication with a user interface 75. A user interface 75 may display, for example, a map, a menu, a selection screen and/or the like. For example, the user interface 75 may display a map illustrating roads, restaurants, businesses and/or the like. The map may have an arrow, a dot, a mark and/or the like which may be controlled by a user 69 to change views of the map and/or to move the arrow to a location, for example, south of a current view of the map. A user 69 may move the first shaft 7 and/or the second shaft 9 of the optical encoder 4 to output an electrical signal to the processing unit 71. The processing unit 71 may convert the electrical signal to a location and/or to a position of the first shaft 7 and/or the second shaft 9. The processing unit 71 may move the arrow in a direction corresponding to the location and/or the position of the first shaft 7 and/or the second shaft 9. The present invention should not be deemed limited to the specific user interface. The processing unit and/or the processing unit may be applied to any technology known to one having ordinary skill in the art.

The housing 5 may have, for example, the top portion 15 and the bottom portion 13 which may be attached to and/or secured to the pins 17a-17d to define an interior of the housing 5. The first shaft 7 may extend through the housing 5. Moving, rotating and/or turning the first shaft 7 may move, may slide and/or may rotate the slide plates 63a,63b which may allow light to transmit from the light emitting element 41b to the light detectors 55a-55c. The first shaft 7 may extend through the second shaft 9. Rotating the second shaft 9 may move the shutter 47 to allow light from the light emitting element 41a to transmit to the light detectors 55a-55c. A detector board 53 may output a signal based on the amount of light and/or the direction of light received from the light emitting elements 41a,41b. The signal may correspond to a position of the first shaft 7 and/or the second shaft 9.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. An optical encoder comprising:
a housing having an interior wherein the interior is defined between a top side and a bottom side;
a first shaft connected to the interior of the housing wherein the first shaft extends outward with respect to the interior of the housing through the top side of the housing to a point exterior to the housing;
a light emitting element connected to the interior of the housing wherein the light emitting element transmits an amount of light within the interior of the housing;
a light detector connected to the interior of the housing wherein the light detector detects the amount of light transmitted from the light emitting element; and
a plate connected to the interior of the housing and the first shaft wherein the plate is located between the light emitting element and the light detector wherein movement of the first shaft from a first position to a second position moves the slide plate to change the amount of light detected by the light detector.

2. The optical encoder of claim 1 further comprising:
a second shaft connected to the interior of the housing and the plate wherein the second shaft extends outward with respect to the interior of the housing.

3. The optical encoder of claim 1 further comprising:
a shutter connected to the first shaft wherein movement of the shutter changes the amount of light detected by the light detector.

4. The optical encoder of claim 1 further comprising:
a cable connected to the light detector wherein the cable transmits a signal based on the amount of light detected by the light detector.

5. The optical encoder of claim 1 further comprising:
a push button within the housing wherein depressing the shaft contacts the push button.

6. The optical encoder of claim 1 further comprising:
a plate connected to the first shaft wherein the plate separates the light emitting element from the light detector.

7. A system for encoding an amount of light, the system comprising:
a housing having an interior wherein the interior is defined between a top side and a bottom side;
a first shaft connected to the interior of the housing wherein the first shaft extends outward with respect to the interior of the housing through the top side of the housing to a point exterior to the housing;
a light emitting element connected to the interior of the housing wherein the light emitting element transmits an amount of light within the interior of the housing;
a light detector connected to the interior of the housing wherein the light detector detects the amount of light transmitted from the light emitting element;
a shutter connected to the interior of the housing and the first shaft wherein the shutter is located between the light emitting element and the light detector and further wherein the first shaft rotates from a first position to a second position to move the shutter wherein movement of the shutter changes the amount of light detected by the light detector.

8. The system of claim 7 further comprising:
a second shaft connected to the interior of the housing wherein movement of the second shaft changes the amount of light detected by the light detector.

9. The system of claim 7 further comprising:
a plate connected to the first shaft wherein movement of the plate changes the amount of light detected by the light detector.

10. The system of claim 7 further comprising:
a cable connected to the light detector wherein the cable transmits a signal corresponding to the second position of the first shaft.

11. The system of claim 7 further comprising:
a push button within the housing wherein depressing the shaft contacts the push button.

12. The system of claim 7 further comprising:
a plate connected to the first shaft wherein the plate separates the light emitting element from the light detector.

13. The system of claim 7 further comprising:
a ball connected to the top side of the housing wherein movement of the first shaft abuts the ball to produce a sound.

14. A method for using an optical encoder, the method comprising the steps of:
providing a housing having an interior defined between a top side and a bottom side wherein the interior of the housing has a shaft extending outward with respect to the interior through the top side of the housing;
emitting an amount of light within the interior of the housing from the top side of the housing;
detecting the amount of light within the interior of the housing at the bottom side;
changing the amount of light detected at the bottom side via the shaft;
transmitting an electrical signal based on the amount of the light detected within the interior of the housing at the bottom side and further wherein the electrical signal corresponds to a location of the shaft within the interior of the housing.

15. The method of claim 14 further comprising the step of:
inserting a plate between the top side and the bottom side of the interior of the housing wherein movement of the plate changes the amount of light detected at the bottom side of the interior of the housing.

16. The method of claim 14 further comprising the step of:
connecting a light emitting element to the top side of the interior of the housing wherein the light emitting element emits the amount of light into the interior of the housing.

17. The method of claim 14 further comprising the step of:
connecting a light detector to the bottom side of the interior of the housing wherein the light detector detects the amount of light at the bottom side of the interior of the housing.

18. The method of claim 14 further comprising the step of:
contacting a push button with the shaft wherein depressing the shaft contacts the push button to transmit the electrical signal.

19. The method of claim 14 further comprising the step of:
connecting a cable to the housing wherein the electrical signal is transmitted via the cable.

20. The method of claim 14 further comprising the step of:
connecting a shutter to the shaft wherein movement of the shutter changes the amount of light detected at the bottom side of the interior of the housing.
